(19) United States
(12) Patent Application Publication
(10) Pub. No.: US 2013/0087612 A1
(43) Pub. Date: Apr. 11, 2013

(54) METHOD AND DEVICES FOR THE PRODUCTION AND USE OF AN IDENTIFICATION DOCUMENT THAT CAN BE DISPLAYED ON A MOBILE DEVICE.

(71) Applicant: Swiss Technical Electronics (STE) Holding Ag, Vaduz (LI)

(72) Inventor: Johann Kaspar LOCHER, Neulengbach (AT)

(73) Assignee: Swiss Technical Electronics (STE) Holding Ag, Vaduz (LI)

(21) Appl. No.: 13/687,285

(22) Filed: Nov. 28, 2012

Related U.S. Application Data
(63) Continuation of application No. PCT/EP2010/003256, filed on May 28, 2010.

(51) Int. Cl. G06K 19/06; G06K 5/00

(52) U.S. Cl. CPC G06K 19/06009; G06K 5/00
USPC 235/380; 235/487

(57) ABSTRACT

A method for producing an identification document that can be displayed on a mobile communication device of an ID user and a server arrangement for carrying out the method, an identification document, in particular for the authentication of authorizations or qualifications of a person and the use of this identification document for processing transactions at a transaction terminal and a method for the management of the identification documents.

This nonprovisional application is a continuation of International Application No. PCT/EP2010/003256, which was filed on May 28, 2010, and which is herein incorporated by reference.

### BACKGROUND OF THE INVENTION

1. Field of the Invention

The invention relates to a method for producing an identification document that can be displayed on a mobile communication device of an ID user and a server arrangement for carrying out the method. Furthermore, the invention relates to an identification document, in particular for the authentication of authorizations or qualifications of a person, the use of this identification document for processing transactions at a transaction terminal and a method for the management of the identification documents.

2. Description of the Background Art

The term “identification document,” as used herein, denotes any kind of feature combinations that are linked to the identity of a person and based on which the identity of the user, certain legal properties or authorizations and/or other circumstances linked to the person of the user can be extrapolated. The physical nature of the identification document is not limited to certain forms, instead the term covers all feature combinations that can be used as an ID in the broadest sense. In particular an identification document is used to authenticate authorizations or qualifications of the person.

Credit cards and bankcards are also to be seen as IDs within the meaning of the invention. These have been part of everyday life for many years and are used to pay for goods and services. For payment, the currently necessary credit card is shown, the data shown thereon are usually detected in an electronic manner by reading a magnetic strip arranged on the card or a chip integrated into the card and sent for billing to a central database of the credit card provider. To prove the identity of the payer, usually in addition a printed receipt must be signed manually by the user. Credit cards are also used for the payment of Internet orders, wherein, naturally, a proof of identity with a signature is not possible thereby. In addition, credit cards and bankcards frequently make it possible to withdraw cash from ATMs, wherein a secret PIN code has to be entered for identification. Unfortunately, this type of payment transaction provides many possibilities for misuse, so that there are new reports of credit card theft and card misuse in the media almost daily. This represents an enormous problem not only for the providers of credit cards, but also leads to high liability risks for credit card users or, under some circumstances, also among the credit institutions or banking institutions responsible. In particular when the secret PIN code is found out, it is often difficult for the user to prove his innocence and the observed caution in dealing with the PIN code.

IDs are also issued in credit card format by official authorities as well as private individuals, since these have a handy size, can be easily produced in a computer-assisted manner and furthermore provide the possibility of using security features, such as a hologram, an ID photo or an integrated circuit (smart card) installed in the card, so that good protection against counterfeiting is achieved. Thus cards are used not only for official documents, such as driver's licenses, social security cards or identity cards, but also by companies as identification documents, such as for access control systems or as authorization cards for IT systems. Compared to the conventional cards, smart cards provide the additional option of being able to store any data on the card.

Another large field of application for the check card format are cards that are issued by companies to their customers in the course of customer loyalty programs. Loyalty cards offer the customer special advantages in the form of free gifts, bonuses and other incentives and often have their own credit card function.

In the meantime almost every consumer has a number of plastic cards from a variety of providers and it is often no longer even possible to fit all of the cards together in a handy wallet.

Due to the broad use of the check card format and the high sales associated therewith, there is a strong inducement for criminals to circumvent the security measures of these cards and to use someone else's cards for improper purposes. Current systems often offer only a low resistance to offenders, since the possession of the physical card itself is not even necessary for misuse, the possession of a copy of the data stored on the card is often sufficient. These data can be stolen relatively easily, for example, by briefly removing and copying the card, by intercepting Internet transactions in which card data are transmitted or by using so-called “card skimmers.” Card skimmers are small electronic reader devices, which are adhered by criminals over the card insert slot of publicly accessible ATMs without closing the slot. The skimmers read the magnetic strip of the cards while the cards are inserted into the ATM slots. The function of the ATMs is not impeded thereby, since the data thieves want the cardholders to also enter their secret PIN code into the keypad of the ATM. The entry is thereby filmed by a mini camera hidden in the skimmer, so that the entered PIN is discernible on the recording. The skimmers are coordinated with certain designs of ATM and the camera is installed in the skimmers such that the keypad of the ATM is in the field of view of the camera. After a time, the skimmer is removed by the criminal again and the data recorded thereon are evaluated. Copies of the card can be made with the aid of the data with low technical expenditure. It is particularly disadvantageous for the customer who has been stolen from that the thieves are also in possession of the valid PIN code and can withdraw money from the cardholder's account with the card copy. It would be desirable to create identification documents that cannot be copied even if a thief has all of the data that are stored on the card. It would also be desirable to create a system in which the PIN entry takes place on a device not publicly accessible, which thus is protected against tampering.

A more simple, but likewise very widespread method that thieves use in order to get someone else's card and the associated PIN code is detecting the PIN entry at ATMs or payment terminals. Detecting the PIN entry is often not difficult, since the key blocks on ATMs are often arranged in such an exposed manner that a hidden entry of the PIN is only possible for the user with great difficulty. As soon as the PIN has been detected, the card is pilfered unnoticed by a trick theft. Using the card the thief or his instigators can then make payments or withdraw cash unauthorized until the theft is noticed and the card is blocked or until the credit limit is reached or the account is empty. In these cases the customer is often liable for the entire damages, since the bank assumes that he has not exercised enough care in keeping the PIN code secret. It would be desirable to render possible a less exposed PIN entry than is possible with the current systems.

A further disadvantage of the check card format lies in fact that it is not usually noticed that individual cards are missing until the card is to be used. Therefore there is often a substantial period of time between the time of the theft and the time at which the theft is discovered, which makes it possible for the thief to cause a large amount of damage before the card can be blocked. There is a need for ID systems the theft of which is noticed more quickly by the card user than is currently the case.

The disadvantages and problems described above are solved or reduced by the features of the present invention as it is defined in the attached claims.

### SUMMARY OF THE INVENTION

The method for the production of an identification document that can be displayed on a mobile communication device of an ID user according to the invention has the following steps at an authority issuing the ID: receiving an ID production order from an ID provider, wherein at least one user identifier suitable for communication addressing on a standard basis and an ID image is given by the ID provider, provision of the ID image via a download address and transmission of the download address to the mobile device of a user.

“ID image” denotes the optical representation of the ID. IDs in credit card format are composed, for example, of a front and a back of the card.

“ID provider” within the meaning of the invention denotes that authority that a user contacts in order to obtain an ID.

A “user identifier suitable for communication addressing” within the meaning of the invention is considered to be an identifier that on the one hand permits an assignment to a specific user and which on the other hand is used systematically as an address identifier for automated communication with a user device. A user identifier suitable for communication addressing on a standard basis is considered to be in particular the telephone number of a mobile phone that is assigned uniquely worldwide to a specific person (the telephone contract holder) and (via the SIM card) a specific mobile device. The prerequisites are currently also met by e-mail addresses, wherein the mobile phone number due to the SIM card permits a more unequivocal assignment to a specific hardware. If the e-mail address alone provides an assignment to a specific device (tablet PC, portable game console, iPod Touch, reader, e.g., Kindle, etc.) with inadequate security for a certain ID application, in addition an assignment by information on the operating system, the model or a hardware number can be combined with the address.

This dual function of the user identifier—proof of identity on the one hand and device address on the other—permits the implementation of ID documents that are extraordinarily secure against counterfeiting and misuse. Although many mobile devices are able to communicate, such as via a WLAN connection, they are not operated in a telephone network. Such devices can be, for example, music players and movie players (such as the devices sold as “iPod Touch” by Apple), mobile game consoles, tablet computers, e-book readers or other portable computer devices that have a WLAN communication ability. In order to be able to buy new programs or new content for these devices, the owner of the device has to register with the provider, usually giving his e-mail address. An e-mail address can thus also be seen as a user identifier suitable on a standard basis for communication addressing within the meaning of the invention. Optionally, the user identifier can contain a hardware identifier of the device user in addition to the e-mail address, so that mistaking the addressee (and thus a misuse of the ID) is ruled out even when a user uses several similar devices. The registered e-mail address in connection with the operating system used on the user's mobile device in many cases is already sufficient to render possible an unequivocal assignment.

The method according to an embodiment of the invention shifts the expenditure that has to be made for the security of the ID from the ID provider to the authority issuing the ID (which is also referred to below as “service provider” for the sake of simplicity). Therefore with the aid of the present invention, an ID provider can use all of the security features offered by the service provider for the IDs issued thereby regardless of the number IDS produced by him. For example, a small retailer can thereby produce a customer bonus card for his regular customers that is provided with the same high security features that are also used by the credit cards offered via the same system by a major worldwide credit card provider.

The method can have as a further step the generation of a PIN code. The use of PIN codes increases the security of IDs enormously, since the use of an ID provided with a PIN code can be linked to the query of the PIN code. The term “PIN code” in general denotes a sequence of letters or numbers that is known only to the owner of an identification document and is secret with respect to third parties. PIN codes are particularly common that are composed of a four-digit numerical sequence and are either predetermined or can be selected and/or changed by the user.

In an embodiment, the transmission of the download address can be carried out after a verification of the PIN code. The PIN code, which has been provided to the user beforehand, ensures that the download address can be obtained only by the correct ID provider.

As an additional security feature, the method can have as further steps the production of a machine-readable code that can be optically displayed and the integration of the code into the ID image. This renders possible a versatile computer-assisted use of the ID, since the code can be scanned in and processed automatically. The code itself in turn can be provided with further security features.

The term “machine-readable code that can be displayed optically” denotes all types of feature combinations that can be displayed optically, which can be read in via mechanical devices such as scanners, cameras, barcode readers etc. and can be converted into a digital value by a microprocessor. Examples of machine-readable codes that can be displayed optically include 1D, 2D, 3D and 4D codes. With 1D codes the optical features are plotted on only one axis, the best known example of this are the generally conventional bar codes (e.g., EAN-13, EAN-8, UPC-A, UPC-B, UPC-C, UPC-D, UPC-E, IAN, JAN, ITF, ISBN, ISSN, Code 39, Code 93, Code 128, etc.). With 2D codes, the optical features are plotted on two axes, wherein a distinction is made between stacked 1D codes (e.g. PDF417, Codablock) and array codes (e.g., QR code, DataMatrix, Aztec-Code). 3D codes have in addition color or brightness shades, 4D codes are in addition animated, i.e. their features change over time. Biometric codes, such as fingerprints, iris scans or standardized passport photos can also be seen as machine-readable codes that can be optically displayed.

In an embodiment according to the invention before the transmission of the download address a message can be sent to the mobile device, wherein the message contains information for the user, optionally the PIN code and a link to the download of an application that can run on the mobile device. The further communication between the service provider and the mobile device can thereby be made dependent on the installation of the application on the mobile device, so that security checks can also be carried out on the mobile device itself. Tampering with (or “hacking”) an application running on the mobile device requires a considerable effort, of which only specialists are capable. Proprietary systems (such as, for example, the operating software used by Apple for the iPhone or the iPad) have strict security features that make it difficult to misuse the mobile device and thus make the method according to the invention more secure.

In an embodiment, the communication with the mobile device, and in particular with the application running on the mobile device, can be carried out via a communications server (Box B) on which no ID image data are stored. If a hacker should be able to made a successful attack on the communications server via the application, he could thus steal at most only the active download addresses for the IDs just produced and not yet retrieved, but not the ID data of the active IDs. Due to the small possible profit, the motivation to make an attack on the communications server will also be small for data thieves.

In an embodiment furthermore the ID issuing authority can be notified of a user password with the ID production order, wherein downloading the ID image requires a password entry. In contrast to a PIN code, this user password is already known to the user from his communication with the ID provider, so that the service provider does not need to give the user the password again. Cracking the password is therefore made much more difficult for offenders.

According to the invention, the server arrangement for carrying out the method for producing ID documents is characterized in that the arrangement has a data server (Box A) and a communications server (Box B), wherein the communications server is embodied in order to communicate with the mobile communication device and with a mobile application running on the mobile communication device, and in order to receive notification requests from the data server (Box A) and wherein the data server (Box A) is embodied to receive ID production orders from ID providers in order to provide ID images for download and in order to transmit notification requests to the communications server (Box B).

The “two-part” server arrangement of this type provides high security against attacks since there are no data that are susceptible to misuse on the communications server, which due to the necessary interfaces to the mobile devices, under certain circumstances is exposed to a greater risk of unauthorized access. In connection with the above listed security features of the method for producing ID documents, the system can be operated with the highest possible security requirements. Also an offender cannot “intercept” or copy the identification document in an authorized manner by means of the interception of communication between Box B and the mobile device. If the system is designed for mobile devices with different operating systems, several communication serves can also be provided which are respectively designed for an individual operating system or for a group of operating systems.

An embodiment of the server arrangement can provide that the data sever (Box A) has an interface to a service provider Web site, on which user accounts of ID providers are managed. The service provider Web site makes it possible for ID providers to produce IDS quickly, easily and cost-effectively for a variety of applications. IDs can be designed and ordered, for example, by means of a Java application that runs on the service provider Web site, based on general templates or on an ID design provider by the provider.

In a further embodiment of the invention the data server (Box A) can be embodied in order to receive ID production orders that are generated with production software running in the network or on the computer of an ID provider. The production software can be sold as a computer program product and is advantageous for providers who regularly produce and manage a larger number of IDs. Alternatively, interfaces for existing customer management systems can be specially produced in order to provide “large-scale providers” such as credit card companies, business groups or ticket sales centers, for instance, with a provider-specific software solution.

In an embodiment it can be provided that the communication between the data server (Box A) and the communications server (Box B) runs in only one direction, namely from Box A to Box B. Access to the sensitive data stored on the data server from a hacked Box B is therefore impossible.

The invention further relates to an identification document in particular for the authentication of authorizations or qualifications of a person, composed of a mobile communication device capable of image display and assigned to the person, which mobile communication device has a display unit, an operating unit and a memory. An ID data set stored in the memory is assigned to data that are stored and managed in a central database and an optical identifying feature assigned to the ID data set can be displayed on the display unit of the communication device, wherein the optical identifying feature has a machine-readable code that can be optically displayed.

The basis for the invention is the realization that mobile devices that are suitable for communication always have a unique (worldwide or within the system limits) identifier. In the case of mobile phones, this is the telephone number, for example, which (together with the area code) assigns each device a number that is unique worldwide. In the case of other devices that can communicate via WLAN networks, the user identifier can be an e-mail address of the user either alone or in combination with further information via the mobile device. In addition each mobile phone and many other mobile devices are always assigned to a (legal or natural) entity via the contract with the provider. Through the combination of identification document and mobile communication device, the embodiments of the invention render possible a hitherto unachieved level of security, the expenditure for the user of the ID documents beings minimal. The invention can be used in a variety of fields, for example, for conventional identification documents (driver's license, identity card, company ID, student ID, club ID, etc.), for credit cards, for loyalty cards, for access documents, or for IDs with one-time validity, such as admission tickets or gift certificates.

The invention offers a high degree of user friendliness, since neither paper nor plastic needs to be used for the production of the identification documents. This also minimizes the production costs, since the provider needs only to take care of the design of the identification document. The correspondence between the provider and user of the identification document can take place largely or entirely via modern communication networks, so that the expense for letterhead, printing, shipping and postage is minimized. The costs incurred for digital transmission (e.g., fees for SMS or MMS) are much lower than the costs of sending mail. Furthermore, the processing can be automated to a high degree so that the devices and methods according to the invention can also be attractive for providers with low personnel costs and manageable clienteles.

For the user of the invention it is advantageous that virtually any number of different ID documents can be used in a space-saving manner with one mobile device. It is possible to carry out allowable changes to the ID documents at any time, wherein this applies to the user as well as to the provider.

While the loss of conventional IDs often goes unnoticed for some time, the user often already notices the absence of a mobile communication device, such as a mobile phone, smart phone, PDA, tablet PC or similar device, which in general is used at least several times a day, after only a few minutes. The critical period for misuse of a stolen ID, which in general lies between the theft and the discovery or report of the theft, is therefore reduced to a minimal period so that measures can be taken before the stolen device can be misused.

In connection with the further systems, methods and uses according to the invention, it is possible to prevent criminals, if they are in possession only of the ID data, from misusing the ID documents, since due to the security measures according to the invention it can be ruled out that the data can be used alone without the associated mobile phone. An identification document on the “wrong” mobile device can be recognized immediately based on the security features. The additional security measures listed in detail in the specification make it possible to build up extremely high obstacles against misuse.

The present invention is particularly advantageous in connection with computer-based payment systems. For the provider of the goods and services to be paid for the advantage results of a simple conversion to the new payment system. For example, an existing barcode scanner can be quickly converted to the new payment system by a simple installation of software (for example, by the installation of a Java template on the control unit of the scanner) without any additional hardware requirement.

Payment at vending machines can also be carried out much more securely than is currently possible with the known systems.

Loyalty card systems can be implemented quickly and easily by means of the invention. Since the “production” of the loyalty cards is based exclusively on digital means, the “starting costs” which providers have to pay to implement a loyalty card system are extremely low. It is thus also possible for small companies, even for sole proprietorships such as specialized retailers or small Internet providers, with the devices and methods according to the invention to produce their own loyalty cards and thus to generate value that previously was reserved for large chain stores.

In an embodiment, the machine-readable code can contain at least a license code, a user identifier suitable on a standard basis for communication addressing, a PIN code and one or more test values. This combination of security features can be improved in a further advantageous embodiment in that the machine-readable code is formed by at least three test values, wherein one test value is calculated on the basis of two other test values.

In an embodiment of the invention the ID can be a credit card, a loyalty card, an access authorization card, an event ticket, a gift certificate, an identity card, a club card or a similar card. However, an ID provider is not limited to these purposes, but can freely create, design and send to users IDs at his own discretion and according to his own requirements.

In an embodiment the ID can be provided with an expiration date, wherein this feature can also be freely selected by the ID provider as required.

In an embodiment the ID data set can contain hidden information on the operating system of the mobile device for which the ID was issued. On the one hand this is a security feature, on the other hand it permits a restriction of the use of the IDs on proprietary systems. Charging services to the end user is thereby likewise more easily possible.

According to the invention an identification document described above can be used for processing transactions at a transaction terminal, wherein the use has the following steps: readout of data of the identification document displayed on the communication device, verification of the readout data and performance of the transaction. This use is extremely easy to carry out for all of the parties involved.

In an embodiment, the readout can be carried out by scanning in the machine-readable code that can be optically displayed. Scanners are now available on a standard basis at many existing transaction terminals, such as checkout or access systems, and are thus available for the use according to the invention.

In an embodiment of the invention, the verification can comprise the online query in a database. This increases security, wherein the verification can comprise the query of a PIN code.

A transaction can be a procedure in which the ID is used, for example, a payment procedure, an admission authorization verification, a gift certificate redemption, a ticket check, an identity check or an authorization verification.

The invention furthermore relates to a method for the management of identification documents on a mobile device by means of an application running on the mobile device, wherein the method comprises the following steps: retrieval of identification documents provided under a download address, storage of the retrieved IDs in the memory of the mobile device and display of an ID on the display of the mobile device as a reaction to the selection of the ID by the user.

An application of this type can be sold profitably and also permits a billing of services (in particular with retrieval and use of IDs). The billing can be carried out for example on the basis of the number of the IDs used by a user, on the basis of the duration of the use authorization, on the basis of the number of transactions conducted or a mixture of these billing forms.

In an embodiment the method can comprise as a further step the query of a PIN code entered by the user. Thus the authorization to use the ID can also be carried out directly on the mobile device by the application. In particular on proprietary systems many security features are provided against tampering with the application, which help to prevent misuse.

In order to further increase security, the method can comprise as a further step the verification of the PIN code. The verification can thereby be carried out online (by querying a database) or offline (only by the application).

In an embodiment the method according to the invention can comprise keeping a chronological log file for each managed ID, wherein the production data and change data of the ID and all of the transactions conducted with the ID are listed in the log file. This renders possible an analysis of the use of the ID by the user. The collected log data can either serve the use of the ID (e.g., for bonus programs) or be statistically gathered and evaluated centrally for many users. To this end extracts of the data can be transmitted by the application at certain intervals to a statistics database of the service provider.

In an embodiment, the method can comprise the storage of use data, such as the communication channels used, the time and date of a card retrieval, the location data measured during a card retrieval via satellite navigation systems (in particular GPS or Galileo), operating condition data of the mobile device or similar use data. Above all the recording of the location data permits an assignment of a specific transaction to a specific location and can be queried for security reasons. Above all the use of the Galileo system will render possible a determination of location with a deviation of only a few meters, so that it can be verified whether at the time of the transaction the user (or actually the mobile device) is also at the location at which the transaction is to be carried out.

In a further embodiment gift certificates and actions that are connected with an ID (so-called “bonus transactions”) can be stored in the log file of the ID. This increases the benefit and the value of the ID for the user as well as for the ID provider.

Bonus transactions can be deactivated in an advantageous manner after the expiration of the validity or after the redemption of the bonus transaction, so that the use of the bonus transaction can be verified.

In an embodiment the further use of an ID can be prevented when the ID has expired or has been deleted. The ID provider thus to a certain extent retains control of the IDs issued thereby. The information that an already issued ID is to be deleted by the ID provider can be processed by the service provider via the same communication channels that are also used when producing the ID.

In an embodiment, the log file of an ID can be converted into a history file when an ID is deleted or deactivated. The data obtained during the use of the ID are thereby also available later, for example, when a new ID for the user is issued by the same provider.

In an embodiment, the method according to the invention can further comprise the step that a backup file with the ID data and the log files or history files is created. This facilitates data porting to a new mobile device or the regeneration of lost data.

In an embodiment, the backup file can be encrypted, wherein preferably the user identifier suitable for communication addressing on a standard basis is used as a key. Copying existing ID data onto a device not provided for this can be prevented thereby.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an overview of exemplary networks in which the invention can be used advantageously;

FIG. 2 shows a diagrammatic overview of the parties involved in producing the ID and the steps that are carried out in an exemplary embodiment of the invention to produce an identification document according to the invention;

FIG. 3 shows a diagrammatic flowchart of the steps that are carried out with an exemplary transaction, in this case a payment transaction, according to the invention by different units;

FIG. 4 shows a diagrammatic representation of the structure of an exemplary machine-readable code that can be optically displayed according to the invention;

FIGS. 5-8 show several exemplary embodiments of identification documents according to the invention; and

FIG. 9 shows the user interface of a computer program product according to the invention for managing and handling identification documents.

### DETAILED DESCRIPTION

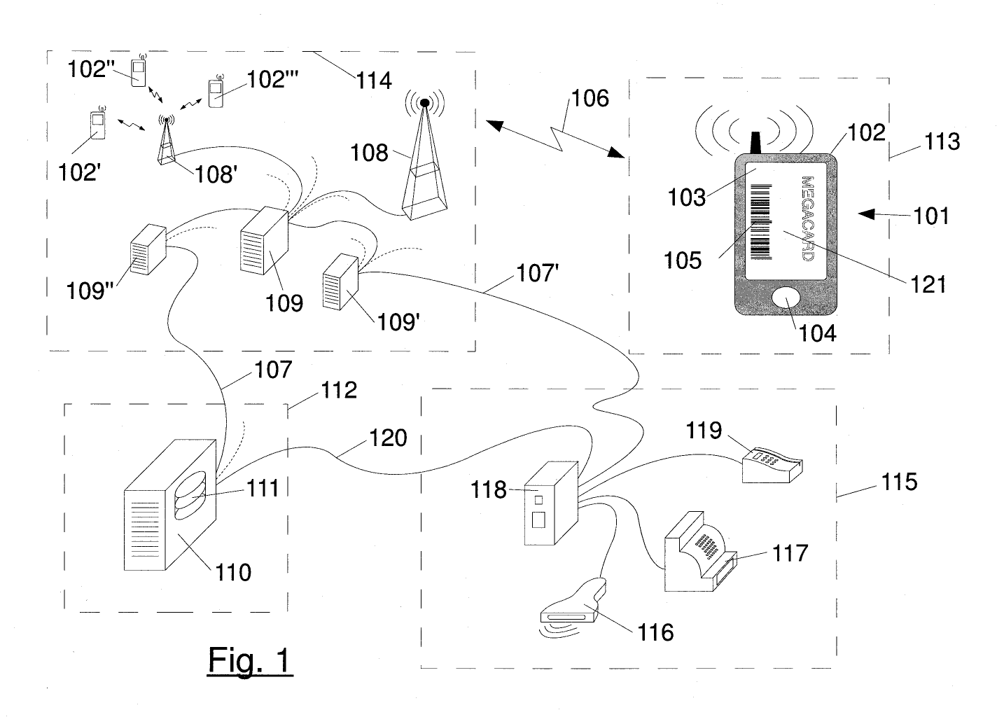

With reference to FIG. 1 now the interconnection of the different units that are involved in different aspects of the present invention are described by way of example. The region marked by reference number 113 represents the ID user or the region of an ID user (or ID holder). The ID user 113 is in possession of a mobile communication device 102, which is capable of wireless communication with at least one radio network. The mobile communication device 102 has at least one display unit 103, an operating unit 104 and an internal memory unit (not shown). The mobile communication device 102 communicates via the radio connection 106 with the transmitter 108 of a cell of a communication network 114.

The term “mobile communication device,” as is used herein, comprises all non-stationary devices with which communication with other units is possible. In particular, mobile communication devices are assigned to one or more public, proprietary or private network(s) and preferably communicate wirelessly with the network. Examples of mobile communication devices are mobile phones, smart phones, PDAs equipped with a communication interface, wireless phones, pagers, radio devices, netbooks, portable game consoles, e-book readers, tablet PCs, etc. Examples of networks include telecommunication networks, in particular mobile radio networks, police and non-police BOS radio networks (“BOS” stands for “Behorden and Organisationen mit Sicherheitsaufgaben” [Security Authorities and Organizations]), Internet, public and proprietary WLAN networks and associations of several different networks.

The communication network 114 is shown merely diagrammatically in FIG. 1 and can be in particular a mobile radio network, WLAN network or an association of several mobile radio, W-LAN and/or LAN networks. The exemplary communication network 114 contains several network servers 109, 109′, 109″, several transmitters 108, 108′, wherein each transmitter 108, 108′ forms one or more cells of the mobile communication network, in which several mobile communication devices 102′, 102″, 102′″ can be used. The communication network 114 can also comprise one or more different networks connected to one another, for example, the invention can be used with WLAN radio networks or other radio networks. The person skilled in the art in the field of mobile communication is familiar with a plurality of networks, so that a more detailed description of all possible combinations of networks is not necessary for a comprehensive description of the invention.

The region denoted by reference number 112 represents a provider or the environment of a provider of an identification document according to the invention. The ID provider 112 operates a provider server 110 on which a central database 111 is located. The ID provider 112 can be a credit card company, for example, wherein the central database then contains data on credit card customers, data about licensees and data about business entries. In this context business customers who offer their customers a credit card entry for the payment transaction are denoted as licensees. The provider server 111 is likewise suitable for communication via communication networks, for example via an Internet connection 107. Optionally, the provider server 110 can also communicate via a secure direct data line 120 with the control unit of a payment terminal 115 of a licensee. Further possible data lines are indicated by dashed lines in FIG. 1.

The region denoted by reference number 115 represents a payment terminal of a licensee and contains a checkout 117, a card terminal 119, a scanner 116 and a control unit 118. The control unit 118 can be a conventional personal computer that has a microprocessor and a communication unit. The control unit 118 is connected, for example via the Internet line 107′, to the communication networks 114, wherein data can be transmitted via this connection to the server 110 of the provider as well as to the mobile communication device 102 of the ID user 113. Optionally, the control unit 118 can communicate securely via the direct data line 120 in a direct manner with the provider server 110. The region 115 can also represent a branch of the provider 112 instead of a licensee.

The mobile communication device 102 of the ID user 113 serves as an identification document 101, wherein an ID data set stored in the memory of the mobile communication device 102 contains an ID image 121, which is displayed on the display unit 103 when the ID user 113 retrieves the representation of the ID image 121 via the operating unit 104 in a menu-assisted manner. The ID image 121 can have, for example, a designation of the identification document (e.g., “megacard”) and a barcode 105 that can be read by means of a scanner directly from the display unit 103 of the mobile communication device 102.

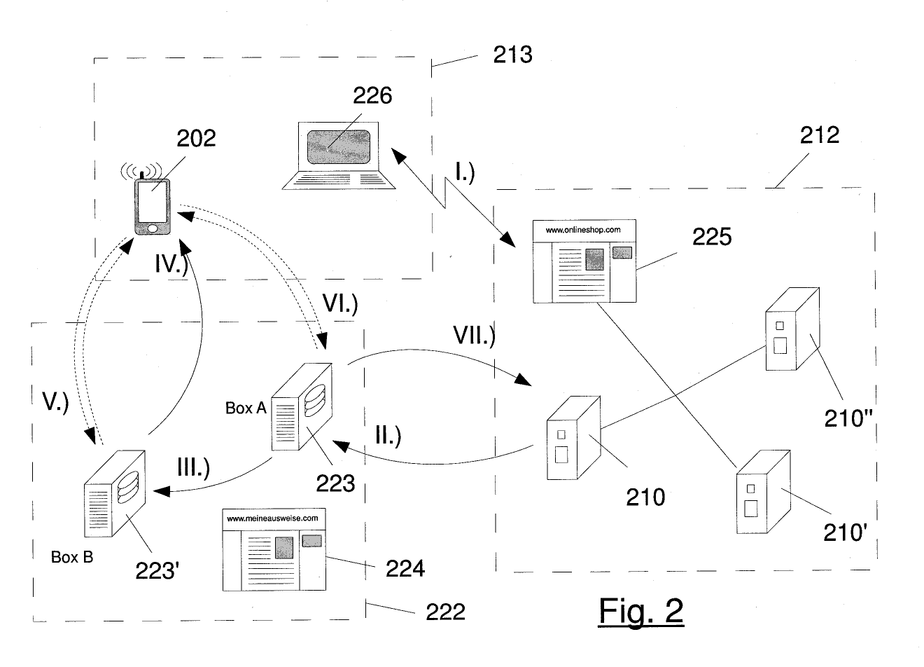

FIG. 2 shows an overview of the parties involved in the production of an ID. They are an ID user (region 213), an ID provider (region 212) and an ID-issuing authority (region 222), which is also referred to below as service provider.

The ID provider 212 could be, for example, a company that operates an online store (e.g., the provider Web site 225). By way of example a network composed of several servers 210, 210′, 210″ of the provider is shown. However, any natural person or legal entity can work as an ID provider, who has a computer with Internet access, who knows the data of the ID user 213, in particular the user identifier of the user (or of the users) and who wants to produce an ID for the user/users.

The ID user 213 has a mobile device 202 which can be addressed via the user identifier and can show image data. Furthermore, the user is in contact in some way with the ID provider, for example, the user could be a customer of the provider's online store. By way of example a computer 226 of the user is shown, with which the online store can be accessed.

The service provider 222 likewise has a server network composed of several servers 223, 223′, wherein the communication with the ID provider is processed via the Internet, for example. To this end either separate interfaces to a computer or network of the provider can be provided, or the provider uses a program offered by the service provider, which provides the interfaces to the service provider. An Internet platform of the service provider can also be used as an interface, for example, a generally accessible service provider Web site 224. On the service provider Web site 224 an ID provider can set up a user account and thus receive access to the ID production software offered by the service provider.

Two regions can be delimited in the server network of the service provider, namely a data server (Box A) and a communications server (Box B). Even if this is shown thus in FIG. 2, Box A and Box B do not inevitably have to be spatially separated from one another, in fact they differ from one another with respect to their interfaces, with respect to the process steps carried out by them and in the type of data managed and stored by them.

Box A has access to the central database on which the ID information and customer information is stored. Furthermore, Box A is in connection with a Web server and can produce and delete Web addresses (so-called URLs) and provide them with content. Box A has interfaces to ID providers and communicates with them. Box A is also in connection with the service provider Web site 224. Optionally, Box A can also provide the service provider Web site 224 as a Web server. Box A is also able to transmit data to the communications server, Box B. However, access to Box A from Box B is not necessary and should not even be possible for security reasons.

Box B is likewise able to produce and delete URLs and to provide them with content. Furthermore Box B (in contrast to Box A) is able to communicate with the supported mobile devices and to this end has the corresponding interfaces. For communication with a mobile device for addressing the user identifier of the user suitable on a standard basis for communication addressing, that is, for example, the telephone number or the e-mail address of the user is used. The communication with the mobile device is carried out either as one-way communication (for example as an SMS, MMS or e-mail message sent to the mobile device) or via an interface to an application running on the mobile device. In the second case the communication can take place in both directions. Box B stores most of the data only temporarily as long as they are necessary for processing a specific transaction. Optionally, Box B can also manage a database in which, for example, the user identifiers of the mobile devices on which an application has already been installed can be stored. The individual steps that are carried out in the production of an ID in general are explained in detail below. It should be noted that not all of the steps described are absolutely necessary to produce an ID according to the invention. The individual steps are labeled by Roman numerals in FIG. 2.

Step I.) Registration of the User with the Provider

The registration of the user can be carried out, for example, online, in writing, in the provider's business, by data entry in the office of the provider, etc. In addition to the master data managed by the provider, the provider knows at least a user identifier (for example, a telephone number or e-mail address). In addition between the provider and the user a user password is agreed, which can also be used for the ID production. The user should also let the provider know which operating system he uses on his device on which the ID is to be produced.

Step II.) ID Production Order (Provider to Service Provider)

The provider commissions the service provider to produce an ID for the user. The order is preferably transmitted online. With the order the service provider is informed of the user identifier, the user password, an ID image and the desired operating system.

The transmission of the ID production order can be carried out via the Java platform on the Web site of the service provider, via a production program purchased by the provider or via an application running on the server of the provider, which communicates directly with the database of the service provider via interfaces. The use of a Java platform is provided in particular for ID providers who want to test the range of the service provider, for providers with a small number of ordered IDs or also for private persons who want to produce IDs for a non-commercial use, for example, as an original invitation to a celebration. The range of the production program is directed in particular to persons, companies or also clubs that regularly produce IDs for several users. A direct interface can also be suitable above all for large-scale providers, credit card companies, ticket sales outlets, etc.

The Java application or the software with which the IDs are produced, can support the production of ID images by providing templates. The images provided by the provider can be brought to the necessary or desired format automatically by the application.

The ID image does not need to be transmitted separately for each ID, but can also be stored on the data server (Box A), for example when a user account is set up for the ID provider on the Web site of the service provider, via which the cards produced by the provider are to be managed.

The ID image in general contains a machine-readable code that can be displayed optically, for example, a barcode, wherein the barcode can also be produced by Box A based on the information from the ID provider and inserted into the ID image.

As soon as the order has been completed by the provider and transmitted to Box A, Box A produces a PIN and stores the data of the ID production order (user identifier, password, image) together with the PIN in a database. The database can also contain further data relevant to the service provider.

Box A further produces on the basis of the ID image the completed ID as a file and a URL used uniquely for the order and produced on a random basis (e.g., by means of HASH algorithms). Then the ID is made available for download via the URL.

Step III.) Notification Request (Box A to Box B)

In the next step the user identifier, the PIN code, the URL and optionally the operating system used by the user are transmitted to Box B. Alternatively, the communications server, Box B, can be used only for a certain operating system. In this case, several communications servers can be present in the network of the service provider, and Box A decides based on the operating system data to which Box B the notification request has to be transmitted. Optionally, Box B can also find out the operating system used by the user in the course of Step IV.) or V.)

It should be noted that in no case does Box B have image data of the ID. Box B does not know the user password that is necessary for the ID download, either.

Step IV.) Production Information (Box B to Mobile Device)

Box B now uses the user identifier in order to send a message via a standardized communication channel (for example, via SMS, MMS or by e-mail) to the mobile device. The message informs the user that an ID has been provided for him for retrieval. Furthermore, it contains the PIN and a download link, via which the application that has to be used on the mobile device for the management of the IDs, can be downloaded for installation.

Step V.) Link Retrieval and PIN Verification (Device and Box B)

When the user decides to use the ID, he first installs the application on his mobile device. The further communication with the service provider can then be managed directly by the application without the user having to concern himself with it.

After the installation, the application prompts the user to enter his PIN. The entered PIN is then transmitted with the user identifier to Box B. Box B now verifies whether the PIN is valid for the user identifier and then transmits to the application the URL of the ID image generated by Box A.

Step VI.) ID Retrieval (Device and Box A)

Next the user is prompted by the application to enter his password (which he received upon registration from the ID provider or has set up with the ID provider) in his mobile device. The application then retrieves the ID image via the URL, wherein the password is checked before the image download. The checking of the password can be carried out simply in that the file deposited under the URL or the URL itself is password protected with the customer password. The image file could also be encrypted with the customer password as key.

Finally, the application provides the ID for use on the mobile device. If the user now retrieves the ID via the application, it is displayed on the display unit of the mobile device and can be used for transactions. For the user the process of ID production is thus completed.

Step VII.) Activation Confirmation/Deleting URL (Box A)

As a standard feature the URL and the identification document are automatically deleted by Box A after a time window has passed (e.g., 24 hours) so that misuse of IDs not retrieved is prevented. If the URL is used by the mobile device for the image download, this can be recorded by Box A and the URL as well as the ID file are deleted directly after successful download. In the event of a recording of the download, a notification can also be sent to the provider in order to inform him that the ID has been downloaded and activated by the user.

Optionally, invoice information can also be produced on the basis of the download record, wherein the services can be billed to the ID provider, to the ID user or to both.

The ID production according to the invention provides advantages for all involved and moreover can be used very flexibly. For the ID provider the design and use of the IDs can be freely selected, wherein the form of the ID image (dimensions, number of pixels, front and back) can usually be predetermined based on the system. Prefabricated templates can be used in the production of the cards, whereby the production can be carried out even by providers with little experience. The provider can manage the customer IDs in the same manner as his previous loyalty cards, so that a changeover from existing ID systems is possible very easily. The existing IDs can continue to be used by users who do not have a mobile device.

The user can manage his IDs easily and centrally via his mobile device and use them for performing a variety of transactions. The number of “physical” IDs, such as the plastic cards carried in his wallet, can be reduced considerably.

The use of the IDs for performing transactions can contain the following steps:

The user needs a certain ID (credit card, loyalty card, authorization ID, key card, ticket, etc.) in order to perform a transaction

The user retrieves the application on his mobile device and searches for the desired ID in the available cards

Optionally, the user is prompted to enter the PIN for the corresponding card before it is displayed

One or both sides of the ID are displayed on the display of the mobile device. The ID can optionally also be turned over (as with a credit card with a front and back)

The ID is shown and verified either by a screener personally or by a terminal in an automated manner (the automatic verification can be carried out by scanning the machine-readable code that can be displayed optically)

The ID transaction is completed from the point of view of the user and the mobile device can be stored away again.

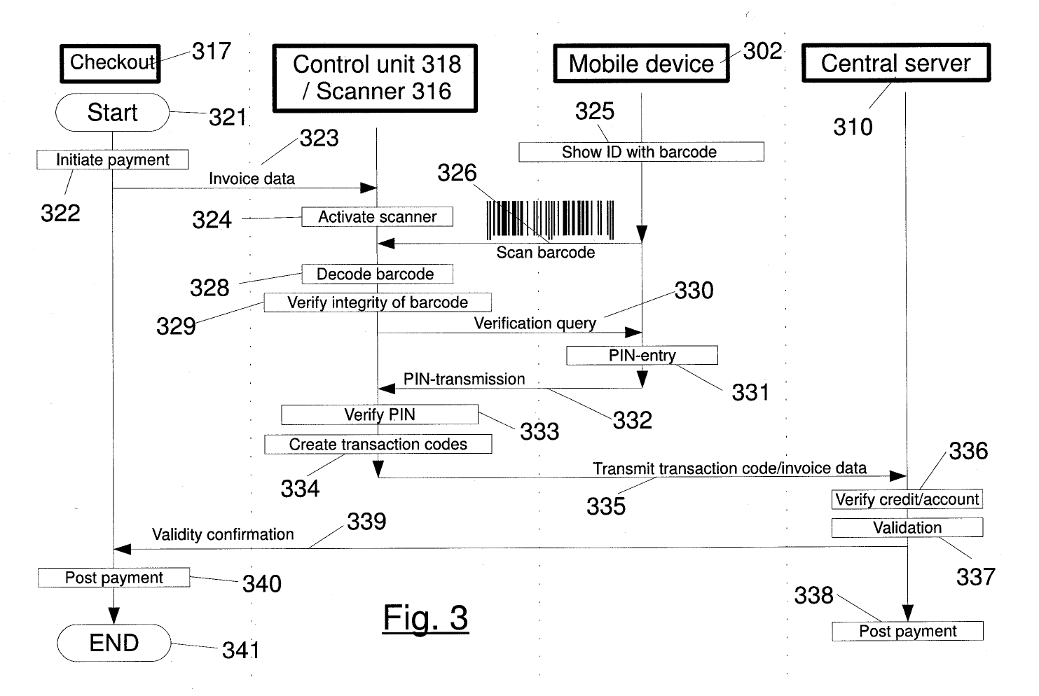

As an example of a transaction, in FIG. 3 a payment process is shown which is carried out by means of a credit card identification document according to the invention. The payment process here relates to four different units that respectively communicate with one another. The payment process starts (321) at a checkout 317, wherein the payment is initiated (step 322). Then the already collected invoice data, in particular the amount to be paid, are transmitted in step 323 from the checkout 317 to a control unit 318, which is connected to a scanner 316. The control unit 318 activates in step 324 the scanner 316 in order thus to read in data. The ID holder retrieves the identification document in his mobile communication device and shows the identification document provided with the barcode in step 325, so that it can be scanned with the scanner 316 (step 326). In step 328 the control unit 318 decodes the barcode, reads out the unique identifier of the mobile device contained in the barcode and verifies in step 329 whether the barcode meets the integrity conditions.

The term “integrity verification,” as used herein, denotes the verification of whether a data set or a code corresponds to a predetermined syntax. An integrity verification is carried out in order to recognize tampering with a code carried out by third parties. In particular the integrity of scanned, machine-readable codes, which were produced based on a formation algorithm, can be verified with respect to compliance with syntactic formation rules of the algorithm.

An integrity verification can alternatively or additionally also be carried out in Step 333 provided later. The integrity verification is carried out on the basis of test values, which are contained in the barcode, wherein the test values were produced by means of various test algorithms based on the data actually contained in the barcode.

The term “test value” denotes in connection with the present invention a value that in the formation of a data set based on a formation algorithm is calculated from the data set and is transmitted with the transmission of the data set with it (or separately) to the receiver. The receiver can compare a security code calculated with the same algorithm with the received test value in order to recognize transmission errors or tampering with the data set. Examples of the use of test values include the cyclic redundancy check (CRC value), cryptographic HASH functions or secure HASH algorithms (SHA).

If the test values contained in the barcode do not correspond to the formation algorithms, this is an indication that the barcode could have been tampered with. It is possible by means of cryptographic measures to produce the test values such that the integrity thereof can be tested, although it is very difficult to find out the formation algorithms.

If the barcode corresponds to the formation algorithms, the control unit 318 sends a verification query 330 to the mobile communication device 302. The term “verify” in connection with the present specification denotes the verification of the identity of a person carrying out a transaction. The identity of the person can be verified, for example, in that he is prompted to enter a secret PIN code known only to the person. The verification query can be an SMS message, for example, with which the ID holder is prompted in step 331 to enter his secret PIN into the mobile device 302 embodied as a mobile phone, for example. After the PIN entry has been made, the mobile phone 302 transmits the PIN preferably by means of a secure transmission to the control unit 318 (step 332). The control unit 318 verifies based on the PIN received by the mobile communication device 302 in step 333 whether the PIN code matches the PIN code contained in the barcode. Through the verification query 330, which was transmitted to the unique identifier of the mobile device 302, and through the response from the mobile device 302, the unique identifier of the mobile device is known to the control device 318 so that it is ensured by the identical identifiers that the identification document is used on the correct mobile device.

After the control unit 318 has verified the integrity of the ID as well as the identity of the ID holder, in step 334 transaction codes are generated in which the data necessary for posting at the credit card company are collected. The transaction code generally contains the identifier uniquely assigned to the mobile device 302 and a license code that characterizes the ID provider. The transaction code together with the invoice data in step 335 is transmitted to the central server 310 of a credit institution. Based on the transmitted data, the central server 310 verifies the credit-worthiness of the ID holder (step 336). In the case of prepaid cards, it is verified whether the prepaid account of the ID holder has sufficient funds for debiting the payment. In addition it is verified in step 337 whether there are other reasons that prevent a debit (“validation”). The term “validate,” as used herein, denotes the confirmation of the validity of an identification document. An identification document is valid when it is identified as valid in an associated central database. An identification document can be identified as invalid in particular when an expiration date assigned to the ID has passed, when theft or loss of the document has been notified, or if another event, such as non-payment of an invoice, has ended the validity of the identification document. In particular, it is verified whether a block of the identification document is registered in the central database. The term “block” in connection with this specification means flagging an identification document permanently as invalid. It is irrelevant thereby whether the block is shown only in the central database or whether the identification document itself is flagged as blocked. A blocked identification document is always invalid. If the prerequisites for a posting are given, a validity confirmation 339 is transmitted to the checkout 317 and the central server 310 initiates the posting of the payment transaction (step 338). The payment is also posted at the checkout 317 after receipt of the validity confirmation 339 (step 340) whereby the payment process is completed (341).

The payment sequence shown in FIG. 3 contains features that ensure a very high degree of payment security. However, it is not necessary to utilize all of the possible security measures in order to advantageously use the advantages of the invention.

The features of the payment sequence shown in FIG. 3 can also be used for other purposes, such as for the verification of the identity of a person identifying himself, for example, at access or ID checkpoints. In this case, an access control system could be provided instead of the checkout 317. Instead of the invoice data, for example, data on the time and the circumstances (e.g. the access used) could be transmitted. The central server would thereby verify the access authorizations of the person identifying himself for the respective time and access and instead of a posting, would initiate a protocol entry.

A person skilled in the art can easily apply the teaching from the above method to other methods in which a person with an ID according to the invention establishes an authorization and/or qualification and wherein a system has to verify the identity of the person, the integrity of the ID and the validity of the shown authorizations and/or qualifications. Examples of such methods include the verification of tickets for events, wherein the ticket optionally loses its validity upon entry by the person, the redemption of gift certificates for goods and services, which are present in the form of an identification document according to the invention, or the use of an identification document for company employees who identify themselves with an identification document according to the invention with access systems of the company and/or with the use of company resources.

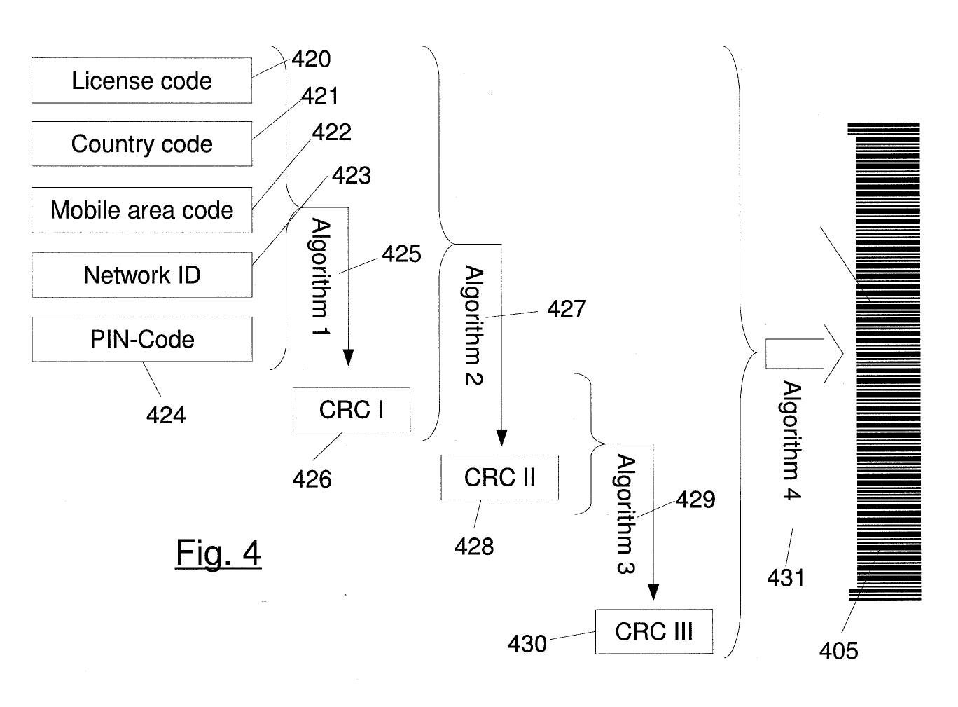

FIG. 4 shows diagrammatically how a barcode 405 according to the invention can be set up. The barcode for an identification document according to the invention contains a license code 420, a country code 421 for the mobile device, a mobile network area code 422 for the network in which the mobile device is operated, a network identifier 423, wherein the network identifier in the case of mobile telephone networks is the telephone number of the mobile phone, and a PIN code 424. In a first step a first test value CRC-I (426) is formed via a first algorithm 425 from the entire data set or from parts of the data set. The person skilled in the art knows different methods for forming test values, wherein different methods can also be used in a combined manner. Examples thereof are methods for cyclic redundancy checks, cryptographic HASH functions or secure HASH algorithms.

The second test value CRC-II (428) is formed via a second algorithm 427 and based on the total output data, including the first test value CRC-I. The two test values CRC-I and CRC-II are in addition converted via a third algorithm 429 into a third test value CRC-III (430). All three test values together with the output data are connected to one another in a fourth algorithm 431 and optionally encrypted and serve as a basis for the barcode 405. Through a suitable selection and combination of known formation algorithms a barcode can be formed that has a high degree of protection against counterfeiting.

Barcodes provide the advantage that they can easily be read by simple scanners, wherein many devices, such as e.g. checkout terminals or access control terminals are already equipped with such scanners. In order to convert these devices to the devices and methods according to the invention, it is necessary only to integrate a program applet into the control software of the scanner, which for example performs the program sequence shown in FIG. 3 for the control unit 318.

The identification documents according to the invention can be used not only for cashless payment, but also for many other ID types, wherein the security features can also be adjusted to the security level required for the respective document. Due to the low costs that are incurred for the production of an identification document according to the invention, it is also possible according to the invention to issue identification documents that have a very short validity period. Thus, for example, gift certificates that are valid for a restricted period can be transmitted to the ID holder as identification documents wherein the gift certificates lose their validity upon redemption or expiration of the validity period. In a preferred embodiment of the present invention, identification documents can also be used to regulate access systems, wherein the identification documents are used either for a long-term use, such as access control systems for employees of a company, or for a short-term use, such as for guest access cards or event tickets.

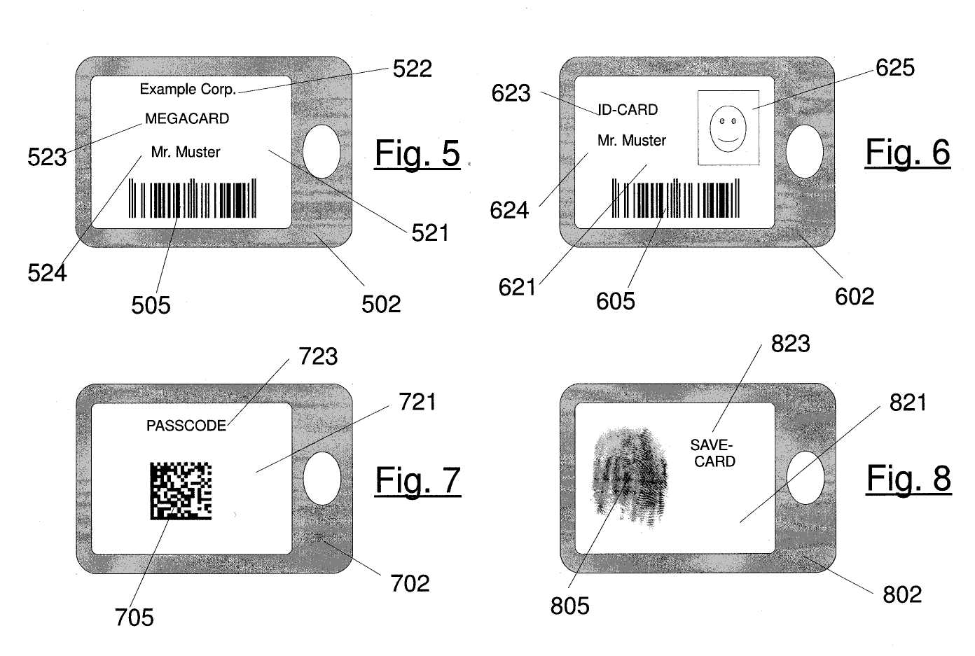

Some exemplary embodiments of identification documents according to the invention are shown in FIGS. 5-8. FIG. 5 shows a loyalty card shown on a mobile communication device 502, which contains an ID image 521, on which a company name 522, a card designation 523, the name of the card holder 524 and a barcode 505 are shown. The display of an individual credit card number is not necessary, since each credit card is assigned via the unique identifier to a specific mobile communication device 502 and a specific holder.

The ID shown in the mobile communication device 602 of FIG. 6 is a proof of identity document, wherein the ID image 621 has an ID designation 623, a holder name 624, a passport photograph (shown in a stylized manner) 625 of the holder and a barcode 605.

FIG. 7 shows an identification document on a mobile device 702 in which the ID image 721 has only an ID designation 723 and a two-dimensional code 725 of the data matrix type. A document of this type could be used, for example, as an (optically readable) key for access control systems.

The identification document of FIG. 8 contained on the mobile communication device 802 has an ID image 821 on which, in addition to the ID designation 823, a fingerprint 805 of the ID holder is shown. The fingerprint 805 replaces the barcode as optical identifying feature, wherein the fingerprint 805 can be read by a scanner and compared to the actual fingerprint of the person identifying himself. An identification document of this type is suitable, for example, for applications in which the identity of the holder person is of particular importance.

A large number of different identification documents according to the invention can be stored and used on each mobile communication device, wherein the possible number of the stored identification documents is limited virtually only by the size of the memory of the mobile communication device. In order to facilitate the handling of a large number of different identification documents stored on a mobile communication device, the application can have an intuitively operable user interface.

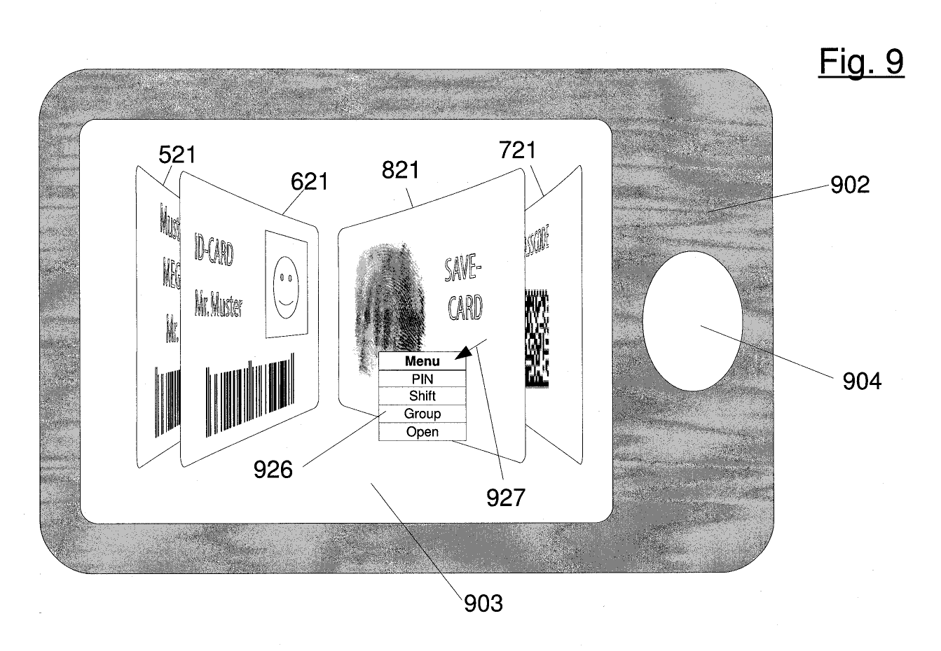

An exemplary embodiment of a user interface for a management and handling program of this type is shown in FIG. 9. The program can be operated either via the operating unit 904 of the mobile communication device 902, or the operation is carried out directly via the display unit 903 embodied as a touch screen. The identification documents 521, 621, 821 and 721 shown on the display unit 903 can thereby be pushed to and fro with a finger or scrolled in a computer-animated manner until the desired identification document is visible. The document can then be brought to the foreground by tapping it with a finger in order to use it. A document just displayed on the display unit can be turned likewise by tapping (or by another gesture) in order to display the rear of the ID. In order to manage a large number of documents, these can be deposited in a subfolder, wherein the storage of an identification document in a subfolder is carried out, for example, by “drag and drop.” In addition, the documents can be divided into groups, wherein common properties are assigned to a group, for example, common security features. A security feature of this type can be, for example, the deactivation of one or more identification documents, when the mobile device has not been used over a defined period of time. In order to be able to use a deactivated identification document again after longer period of non-use of the mobile device, the PIN code of the identification document must be entered into the mobile phone.

The term “deactivation” of an identification document, as used herein, denotes the temporary suppression of the functionality of the identification document. A deactivated identification document can generally be activated again by its user, for example, in that the person's identity is verified.

The application can also contain a function in order to assign the same PIN code to a group of identification documents. To this end the desired PIN code and optionally the PIN codes already assigned to the identification documents is queried and the new PIN code is transmitted to the service provider via a secure connection. Since the PIN code can be contained in the barcode of the documents, with a change of the PIN code these documents need to be reissued by the service provider and again transmitted to the mobile communication device. The method explained in connection with FIG. 2 is used thereby, wherein optionally an individual security code can be used for several transmitted identification documents.

The term “security code” is used herein for codes that are produced on a random basis and transmitted for one-time use to a receiver. Security codes can be used, for example, in order to confirm the correct receipt of a message that can be activated or decoded with the security code. The security code is generally transmitted separately from the message to the receiver. In order to intercept a message for misuse, the offender would have to intercept both messages—the actual message and the message with the security code. Security can be increased in that both messages are transmitted on different channels—for example, one message by SMS or MMS the other message by e-mail or mail.

After successful production of the new identification documents, the application replaces the old identification documents by the new ones.

The application can also have a function that supports the user in the new issue of expired identification documents.

A further feature of the application can be a function for taking over identification documents from a previously used mobile device onto a currently used mobile device. If in this case the unique identifier of the mobile device has also changed, the documents must be issued anew by the service provider or by the provider, wherein the application can process the new issue of several documents collectively. If the newly used mobile device is to be used with the same unique identifier as the previously used mobile device, it can be possible to copy the data sets of the identification documents from one mobile device to the other, for instance via a wired or wireless connection between the two devices or by the replacement of a memory card.

The individual functions of the application can be selected via pull-down menus 926 by tapping on the touch screen or by moving a cursor 927.

With each transaction the application can store the current location coordinates (measured via GPS or Galileo), the date and time of the transaction and further use data in a log file. Preferably there is a separate log file for each ID.

The application thus administers chronological log files for each of IDs managed thereby, in which the production data and change data of the ID, all of the transactions performed with the ID and the use data connected thereto are listed.

Use data can be all data measured by the mobile device, such as the communication channels used, the time of card retrieval or the location data measured via GPS or Galileo with a card retrieval.

With the aid of the log files gift certificates and actions that are connected to the card (so-called “bonus transactions”) can also be managed. Providers for all ID holders or parts thereof can thereby produce bonus transactions and send them to the users via the network of the service provider (wherein the security features used thereby can be lower than with the transmission of the IDs themselves). The management of bonus vouchers is carried out by the application, wherein bonus vouchers not only can be produced for existing IDs, but also can be separate IDs. If the bonus voucher is assigned to an existing ID (e.g., a loyalty card), it is stored in the log file of the card. With the retrieval of the bonus transaction, the PIN can be queried, if this is desired by the provider of the bonus transaction. Optionally, the bonus transaction can be cancelled or deactivated after retrieval by the user (or after a defined number of retrievals).

If the ID provider or the ID user permits this, bonus transactions can also be sent to the user by third parties, that is, by providers that are not the ID provider. Thus ID providers can provide their customer network to third parties in return for payment, wherein the billing of the fee can be processed by the service provider. For example, a publisher could use the customer network of a bookseller in order to promote his products.

The application can mange a plurality of IDs, wherein each ID can be provided with an expiration date. If an ID expires or if it is deleted, the application prevents the further use of the ID, for example, in that the image file of the ID is deleted. With the deletion of an ID the corresponding log file is converted into a history file and continues to be available to the application.

It is also possible with the aid of the application to produce a backup copy of the ID data. The backup file can be encrypted with the user identifier as key, wherein the application restores the cards stored in a backup file only on a device that has an identical user identifier. Thus with a change of device the cards from the backup file can be restored only when the device has the same user identifier as the previous device. With proprietary systems it is also possible to prevent cards from being used on a different operating system for which the corresponding application has not been purchased.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing an identification document that is adapted to be displayed on a mobile communication device of an ID user, the method comprising:
receiving an ID production order from an ID provider, wherein at least one user identifier suitable for communication addressing on a standard basis and an ID image is given by the ID provider;
generating machine readable code that is configured to be optically displayed, the machine readable code having a user identifier that is suitable for communication addressing according to a standard basis;
providing the ID image via a download address; and
transmitting the download address to the mobile communication device.

2. The method according to claim 1, further comprising the step of generating a PIN code, wherein the transmission of the download address takes place after the verification of the PIN code.

3. The method according to claim 1, wherein, before the transmission of the download address, a message is sent to the mobile device, wherein the message contains information for the user and optionally the PIN code and a link to the download of an application that is adapted to run on the mobile device.

4. The method according to claim 1, wherein the communication with the mobile device, and in particular with an application running on the mobile device, is carried out via a communications server on which no ID image data are stored.

5. The method according to claim 1, wherein the ID issuing authority is notified of a user password with the ID production order, and wherein downloading the ID image requires a password entry.

6. A server arrangement for carrying out the method for producing identification documents according to claim 1, the server arrangement comprising:
a data server; and
a communications server configured to communicate with the mobile communication device and with a mobile application running on the mobile communication device in order to receive notification requests from the data server,
wherein the data server is configured to receive ID production orders from ID providers to provide ID images for download and to transmit notification requests to the communications server.

7. The server arrangement according to claim 6, wherein the data sever has an interface to a service provider Web site on which user accounts of ID providers are managed.

8. The server arrangement according to claim 6, wherein the data server is configured to receive ID production orders that are generated with production software running in a network or on a computer of an ID provider.

9. The server arrangement according to claim 6, wherein the communication between the data server and the communications server runs in only one direction, namely from Box A to Box B.

10. An identification document for an authentication of authorizations or qualifications of a person comprising a mobile communication device capable of image display and assigned to the person, the mobile communication device comprising:
a display unit;
an operating unit; and
a memory,
wherein an ID data set stored in the memory is assigned to data that are stored and managed in a central database,
wherein an optical identifying feature assigned to the ID data set is configured to be displayed on the display unit of the communication device, and
wherein the optical identifying feature has a machine-readable code that is configured to be optically displayed, the machine-readable code comprising a user identifier suitable on a standard basis for communication addressing.

11. The identification document according to claim 10, wherein the machine-readable code contains at least a license code, a PIN code and one or more test values.

12. The identification document according to claim 10, wherein the machine-readable code is formed by at least three test values, wherein one test value is calculated on the basis of two other test values.

13. The identification document according to claim 10, wherein the ID is a credit card, a loyalty card, an access authorization card, an event ticket, a gift certificate, an identity card, or a club card.

14. The identification document according to claim 10, wherein the ID is provided with an expiration date.

15. The identification document according to claim 10, wherein the ID data set contains hidden information on an operating system of the mobile device for which the ID was issued.

16. A method for processing transactions at a transaction terminal using an identification document according to claim 10, the method comprising:
reading out of data of the identification document that is displayed on the communication device by scanning the machine-readable code that is optically displayed;
reading out the unique identifier of the mobile device contained in the machine-readable code;
transmitting a verification query to the mobile communication device;
receiving a response from the mobile device;
verifying the identity of the ID holder; and
performing the transaction.

17. The method according to claim 16, wherein the verification comprises an online query in a database.

18. The method according to claim 16, wherein the verification comprises a query of a PIN code.

19. The method according to claim 16, wherein the transaction is a payment procedure, an admission authorization verification, a gift certificate redemption, a ticket check, an identity check, or an authorization verification.

20. The method according to claim 16, wherein, using location data measured by the mobile device, it is verified whether at the time of the transaction the mobile device is at a location at which the transaction is to be carried out.
